(19) United States
(12) Patent Application Publication
(10) Pub. No.: US 2005/0047888 A1
(43) Pub. Date: Mar. 3, 2005

(54) Insert for steel plates

(75) Inventor: Thomas Lyon, Escondido, CA (US)

Correspondence Address: Sanford Astor, Birch, Stewart, Kolasch & Birch, 18th Floor, 10940 Wilshire Blvd., Los Angeles, CA, 90024, US

(73) Assignee: Trench Plate Rental Co.

(21) Appl. No.: 10/651,327

(22) Filed: Aug. 28, 2003

(51) Int. Cl. F16B 37/12

(52) U.S. Cl. 411/178

(57) ABSTRACT

An insert and method for moving a heavy steel plate comprising drilling a hole through the steel plate, threading the hole, threadably attaching a hollow cylindrical insert into the threaded hole in the plate using a locking compound, the insert having male threads on the outer surface and female threads on the inner surface, which are adapted to receive an eyebolt used for lifting and moving the plate.

### BACKGROUND OF THE INVENTION

In the construction industry many contractors use steel plates. These steel plates are often rented to contractors who use them for a variety of purposes, one of which is to cover open trenches for vehicle or foot traffic, another for safety, and yet another to prevent motorists or pedestrians from accidentally driving or falling into an open trench. Steel plates are commonly moved on and off trenches by the contractor, as the job progresses. Steel plates can weigh in excess of 7,400 pounds, therefore handling these very heavy steel plates, can be a constant problem for which several methods have been commonly used.

Steel plates today are commonly handled using a threaded lifting device that requires the steel plate itself to have a threaded lifting hole, usually placed at the center of the plate. The two most common methods for producing the threaded lifting hole are, to drill and tap the steel plate or to weld in a nut or insert. Unfortunately, in the course of business, not all users of the product use the lifting device properly and the result is a steel plate with damaged lifting threads in the lifting hole. Steel plate lifting threads may also be damaged from normal wear and tear or from debris in the threads. Repairing damaged lifting hole threads in a steel plate is very time consuming and costly. Damaged lifting hole threads cannot be easily repaired or, more often than not, cannot be repaired at all, requiring a section of the steel plate that bears the lifting hole to be cut out and a replacement piece welded in it's place.

Various methods are known in the prior art for creating a threaded hole in a steel plate. These are either self-tapping fasteners or welded fasteners. U.S. Pat. No. 3,878,598 to John H. Steward discloses a self-piercing nut and panel assembly and a method of securing a nut in a panel. Steward's method of attachment uses a self-piercing nut and the part is crimped over the edges of the receiving part. Steward requires special tooling for the attachment. In Steward, the nut is secured to the panel by impacting the panel with the flat, piercing face of the nut to punch an opening in the panel receiving the pilot portion, which removes a like configured slug from the panel. The sheared panel edges are then deformed by a die member, inwardly against the side walls, beneath piercing shoulders and downwardly into a bottom groove. This assembly requires considerable additional equipment and once the nut is fixed into the panel, it is not removable.

U.S. Patent Application publication 2002/0102146A1 to Wheeler describes a self-tapping, threaded insert for use in mounting another component on a member on which the insert is mounted. Wheeler requires a pre-drilled and partially tapped hole, and in addition, requires a special tool for installation. Wheeler also requires a countersunk locking service that mates with a flanged shank and requires proper torque for securement. Wheeler's insert has a tapered external thread and employs a cutting surface (fluted cutting edges much like a tap) at the leading edge of the insert, designed for cutting its own threads. As in Steward, a locking flange locks the insert into the panel. It is not removable.

U.S. Pat. No. 5,547,323 to Fang, discloses a threaded bush having a cylindrical body that is designed for holes that do not penetrate the full thickness of the panel into which they are inserted. Fang employs a tapered leading edge and a cutting leading edge designed for cutting into the material of the panel to prevent the bush from loosening out of the hole.

U.S. Pat. No. 4,971,497 to Stoffer, et al. describes a flush mounting fastener system in which the fastener is attached using rivets. Stoffer's fastener is tapered on the leading edge and it has “tangs” designed to spread when the lifting device is inserted to better secure the insert from loosening and coming out.

### BRIEF DESCRIPTION OF THE INVENTION

Applicant's invention comprises a device and method to lift and move heavy steel plates which vary in size and weight and are used in the construction industry, primarily to cover open trenches. The invention comprises a threaded, hardened steel insert. Threading the insert makes it easily replaceable and the insert is easily installed into the plate without special tooling. However, the difficulty is how to lock the insert into the steel plate to prevent an accidental loosening of the insert as the lifting device is threaded into and out of it. The insert is often subjected to severe abuse as is common with rented construction equipment. The insert might also be exposed to harsh chemicals, thus the insert needs to be removable for replacement purposes.

Applicant's method comprises drilling a hole into a steel plate. The hole is then tapped. Applicant's custom inserts are then installed into the threaded hole in the steel plate and are secured from movement by a thermoset plastic thread-locking compound. Applicant's threaded inserts are designed to be threaded into a pre-threaded steel plate without special tooling to install them. They differ from inserts that are welded into the plate by being threaded into the plate instead of being welded. They differ from other “self-tapping inserts” by not employing a cutting edge or being made of a material strong enough to cut steel. They are not “locked” into place and thus are removable. The other prior inserts all use some locking device or welding for securement.

### OBJECTS OF THE INVENTION

It is an object of the present invention to provide a replaceable lifting insert for steel plates that is easy to install and remove.

It is a further object of the invention to provide a replaceable, hardened thread insert for steel plates that employs no method of securement other than the use of a thread-locking compound.

It is a further object of the invention to provide a replaceable threaded insert for steel plates that is strong, durable and able to withstand the abuse by users of the steel plates.

It is yet a further object of the invention to provide a replaceable threaded insert strong enough to handle the weight and shock loading of steel plates.

Yet a further object of the invention is to provide a replaceable threaded insert strong enough to prevent the accidental release of the insert in steel plates.

Still a further object of the invention is to provide multiple locations, other than “centered”, for steel plate lifting devices.

It is also an object of the invention to provide a threaded insert for a steel plate capable of having an eyebolt attached to it for lifting and moving the steel plate.

### BRIEF DESCRIPTION OF THE DRAWINGS

FIG. 1 is a cut away view of a steel plate with an eyebolt attached to it;

FIG. 2 is an exploded view of the plate, an eyebolt and the threaded insert of this invention;

FIG. 3 is a cross-section taken on lines 3-3 of FIG. 1.

### DETAILED DESCRIPTION OF THE INVENTION

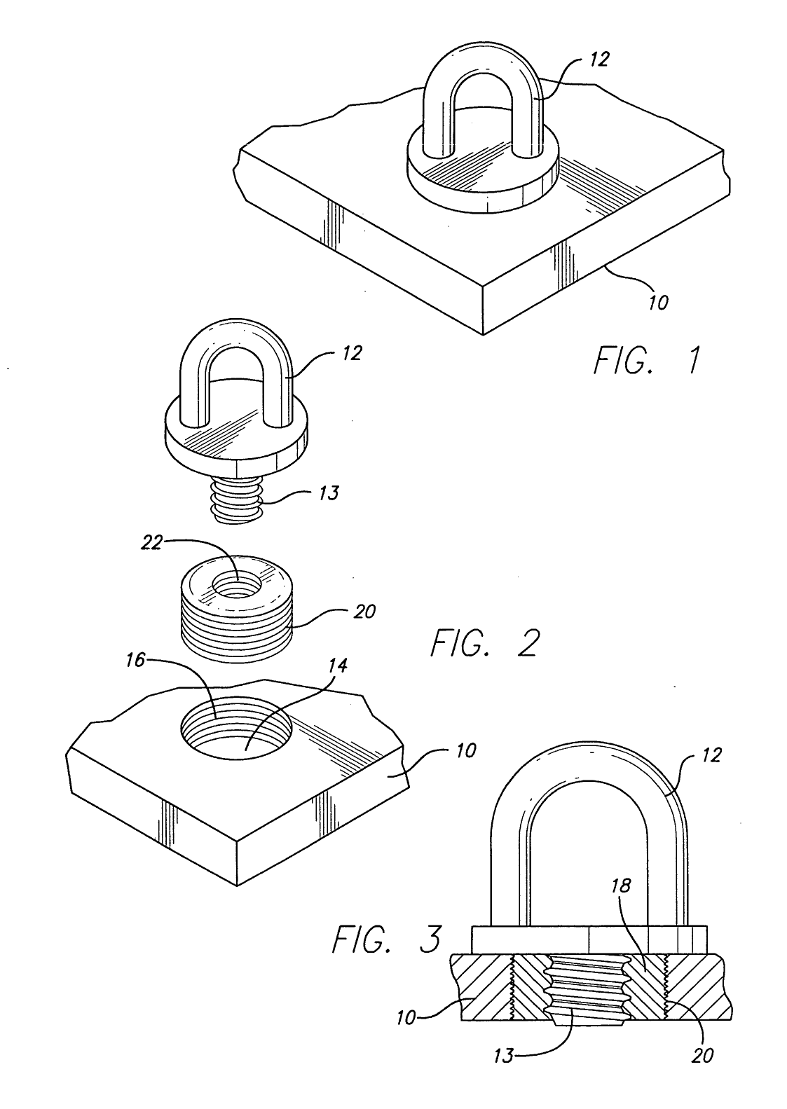

Referring now to the drawings, FIGS. 1, 2 and 3 show a cut-away portion of a steel plate 10. An eyebolt 12, having a threaded shank 13, is attached to steel plate 10. Eyebolt 12 is used to lift and move steel plate 10 by passing a hook or chain through eyebolt 12, the hook or chain being attached to a lifting device such as a crane, crane truck, backhoe, excavator or other equipment used to lift and maneuver steel plates.

The steel plates which are moved by this method are often used to cover holes or trenches in streets or construction sites. The steel plates weigh from about 100 pounds up to about 7,400 pounds, yet they are lifted and moved by attachment to one eyebolt. Due to the heavy weight of the steel plates, a secure method must be used to attach the eyebolt to the steel plate. Often, because of improper insertion of eyebolt 12 into the steel plate 10, normal wear and tear, or the dirt and debris common at construction sites or streets, and the heavy equipment present, the eyebolts and the attachment means for the eyebolt often get damaged and must be repaired or replaced.

Applicant's method for attaching eyebolt 12 to plate 10 is to cut a threaded hole 14 completely through steel plate 10 to provide maximum surface connection. Steel plate 10 is usually marked for center for placement of hole 14, but hole 14 may be located in multiple or other locations in the plate. Hole 14 is then machined to the desired dimension by a rotary cutting tool. Hole 14 is then tapped or threaded using a fluted tap to cut threads 16.

Hollow cylindrical insert 18 having male external threads 20 and female internal threads 22 is then installed using a thread locking product, such as a thermoset plastic retaining compound, such as “Loctite”, manufactured by the Loctite Company. This retaining compound locks insert 18 into threaded hole 14. Eyebolt 12 is then threaded into insert 18.

After steel plate 10 is moved to its new desired location eyebolt 12 is removed. It cannot be left in plate 10 on a street where vehicles travel and cannot usually be left in place at a construction site. After eyebolt 12 is removed, internal threads 22 of insert 18 can be damaged due to normal wear and tear, debris, or rental customers not completely threading the eyebolt 12 into the plate 10 before lifting. If threads 22 cannot be repaired, insert 18 can easily be replaced by applying 300 degrees F., or more, of heat, which chemically changes the locking compound, releasing it's bond and then removing the damaged insert and replacing it with another insert. The heat can be applied with a mixed gas torch or similar device, whereby the applied heat can be controlled. Repair of the threads is not necessary as the damaged insert can be discarded while the threads in the steel plate have been protected by the insert. In the prior art, where self-tapping and locking fasteners are used, it is extremely difficult and time consuming, if not impossible, to remove the fastener without damaging the threads in the steel plate.

While other threads, such as acme threads or U.N.S. threads can be utilized for the internal insert threads 22, coil threads are preferred because they are very strong by design and are best suited for this type of application, can handle debris in the threads with less difficulty and may be cleaned easily, while retaining the high tensile strength needed to lift the heavy weight of the plates. Insert 18 may be threaded into plate hole 14 without any special tool being needed. Insert 18 may vary from about 0.500 inch to about 2.00 inches, but is preferably sized to be substantially the same length as the width of steel plate 10, to fit flush with both the top and bottom surface of plate 10, as shown in FIG. 3. This adds to the protection of both insert 18 and plate 10, while providing the maximum connection surface area for maximum lifting strength. Insert 18 is preferably made of high-grade tempered steel for strength.

The thread locking compound must have a high shear strength to keep insert 20 locked into plate 10 under the great weight of the steel plate. The preferred locking compound was found to be a thermoset plastic such as “Loctite” manufactured by the Locktite. Company. “Loctite” has a shear strength of 4,000 lbs, is virtually unaffected by most chemicals, and has a release temperature of over 300 degrees F., so that it will not release on even very hot days. It has a maximum fill gap of about 0.015 inch. The preferred diameter for threads 16 and 20, to ensure adequate material contact and to prevent thread failure under extreme loading, is from about 2 inches to about 4 inches, preferably about 2 3/16 inches. The threads per inch may vary from about 6 threads per inch to about 32 threads per inch, with about 14 threads per inch (t.p.i.) preferred.

The preferred inside diameter of threads 22 of insert 18 is from about 0.750 inch to about 3.50 inches, with about 1.250 inches preferred.

Test plates were made and tested for tensile strength and the torque capabilities of the assembled components. The test steel plates varied in size and weight. A hole was drilled, then tapped into a steel plate, and the custom inserts of this invention were installed into the threaded steel plate hole and were secured from movement by the thermoset plastic thread-locking compound, “Loctite”. The inserts were made of high tensile strength steel and had a 1.250 inch inside diameter thread called a “coil thread”. A four times safety factor was used for the test limits and all parts passed testing.

TEST #1

Subject: Proof Load Test in Tension of One [1] steel plate with
Threaded Insert Assembly.
Specification: (30,000 lbs. in tension)
Test Machine Utilized: 600,000 lb. Capacity Satec Universal
Testing Machine S/N 1022, last calibrated Jun. 19, 2001 utilizing
NIST. Traceable standards.
Description: 12″ × 12″ × 1″ Steel Plate with 2 3/16″ O.D. × 14
t.p.i. - 60° thread pitch/1¼″ I.D. Coil Thread Insert.

TEST RESULTS ARE AS FOLLOWS:

| | Ultimate Load | Duration, | |
|---|---|---|---|
| Test No. | Lbs. Applied | Seconds | Visual Examination |
| 1 | 30,230 | 10 | No Fractures Observed |

Conclusion: Test complied with specifications. The tensile
force that was applied is theoretically more critical than shear
forces to which the assembly may be exerted in actual usage.

TEST #2

Subject: Torque Proof Load Test of One [1] Trench Plate with
Threaded Insert Assembly with LOCTITE Retaining Compound.
Specification: (1,000 lbs./ft. of torque)
Test Equipment Utilized: 600 lb./ft. Capacity Proto Torque Wrench
S/N 264-X, last calibrated Sep. 13, 2001 utilizing NIST.
traceable standards X-4 Model TD 1000 4× Torque Multiplier.
Description: 9″ × 12″ × 1″ Steel Plate with 2 3/16″ O.D. × 14
t.p.i. - 60° thread pitch/1¼″ I.D. Coil Thread Insert. LOCTITE
Retaining Compound was applied and cured for a period of 24
hours.

TEST RESULTS ARE AS FOLLOWS:

| Test No. | Torque Load | Visual Examination |
|---|---|---|
| 1 | 1,000 lbs./ft. | No observable failure |
| | | (insert withstood torque load) |

Conclusion: Test complied with specifications.

Having thus described the invention, the invention is to be considered limited only by the following claims.

1. A hollow cylindrical insert for a steel plate having a threaded hole cut completely through it, said insert adapted for connection of an eyebolt used for moving the steel plate, said insert having male threads on its outer surface and female threads on its inner surface, said insert having a length substantially equal to the thickness of the steel plate, a thread locking compound between the male threads on the outer surface of the insert and the threads of the hole in the steel plate.

2. The insert of claim 1 in which the insert is made of high-grade tempered steel.

3. The insert of claim 1 in which the female inner threads of the insert are coil threads.

4. The insert of claim 1 in which the female inner threads of the insert are acme threads.

5. The insert of claim 1 in which the female inner threads of the insert are U.N.S. threads.

6. The insert of claim 1 in which the female inner threads of the insert are from about 0.750 inches to about 3.50 inches in diameter.

7. The insert of claim 6 in which the female inner threads of the insert are 1.250 inches in diameter.

8. The insert of claim 1 in which the male outer threads are from about 2.00 inches to about 4.00 inches.

9. The insert of claim 8 in which the male outer threads of the insert are 2 3/16-14 t.p.i. U.N.S. threads.

10. The threads of the insert of claim 8 in which the male outer threads vary from about 6 threads per inch to about 32 threads per inch.

11. A method for moving a steel plate comprising, cutting a hole through the steel plate, threading the hole, inserting into the threaded hole in the steel plate a hollow cylindrical insert having male threads on its outer surface and female threads on its inner surface, said insert having a length substantially equal to the thickness of the steel plate, applying a locking compound to the insert when it is attached to the steel plate, threadably attaching an eyebolt into the threaded insert and removably attaching a lifting device to the eyebolt.

12. The method of claim 11 in which the locking compound is a thermoset plastic retaining compound.

13. The method of claim 11 in which the hole in the steel plate is cut by machining.

14. The method of claim 11 in which the hole in the steel plate is cut at substantially the center of the steel plate.

15. The method of claim 11 in which a plurality of inserts are installed into the steel plate.

16. The method of claim 11 in which the female inner threads of the insert are coil threads.

17. The method of claim 11 in which the insert is removed by heating the insert to loosen the locking compound and unthreading the insert from the steel plate.

18. The method of claim 11 further comprising replacing an insert that has damaged inner female threads by heating the insert to loosen the locking compound and unthreading the insert from the steel plate, and threading a new insert into the steel plate and applying a locking compound to the new insert when it is installed.

19. The method of claim 11 in which threaded holes in the steel plate are cut in multiple locations.

20. The method of claim 11 in which the hole in the steel plate is cut in a location other than substantially at the center of the steel plate.

21. The insert of claim 1 in which the thread locking compound is a thermoset plastic retaining compound.

22. The insert of claim 1 in which the length of the insert ranges from about 0.500 inch to about 2.00 inches.
